(19) United States
(12) Patent Application Publication
(10) Pub. No.: US 2013/0276647 A1
(43) Pub. Date: Oct. 24, 2013

(54) Multi-Stage Waste Material Processing

(71) Applicant: Michael Brule, Whitinsville, MA (US)

(72) Inventor: Michael Brule, Whitinsville, MA (US)

(21) Appl. No.: 13/452,409

(22) Filed: Apr. 20, 2012

(51) Int. Cl. B30B 13/00; B30B 9/28; B30B 15/08; B30B 9/02

(52) U.S. Cl. 100/37; 100/75; 100/48

(57) ABSTRACT

Devices and methods are disclosed for processing waste paper media and other waste fibrous products to reduce their volume. The methods include disintegration and compression, in some embodiments transforming the waste into a highly dense, combustible solid, for example a cylinder which may be burnt as a log or readily stored or transported.

### BACKGROUND

Waste fibrous media, e.g., waste paper and cardboard, occupies space and can be logistically challenging to store and transport for proper disposal or recycling. Shredding waste media effectively reduces its volume, however the process creates large amounts of particulate matter (dust). In addition, shredding waste paper may not completely destroy information contained on the paper. Proper and total information destruction is important to many businesses to ensure that information security standards are met.

### SUMMARY

Generally, this invention relates to devices and methods for processing waste fibrous media and other waste fibrous products to reduce their volume. These methods include disintegration and compression, transforming the waste into a dense solid, for example a cylinder, which may be burnt as a log or readily stored or transported. In some implementations, disintegration of waste paper in this manner completely destroys all information contained on the paper to ensure conformance with strict information security standards such as HIPPA requirements.

The devices disclosed herein may be configured to be used in environments such as offices, ships, prisons, banks, hospitals, and the like, where waste paper needs to be disintegrated to conform with information security standards and/or to reduce its volume, without the creation of excess dust. The devices are relatively compact, require minimal input of electricity (e.g., less than 1.5 kW/hour, in some cases less than 1 kW/hour) and relatively little water. Preferred devices are also are soundproofed, making them well suited for use in an office or similar setting. In some cases, the devices can be integrated into a system that includes a heating unit configured to burn the compressed solid produced by the device, e.g., to heat an office space or other location.

In one aspect, the invention features a device that includes (a) a shredder configured to cut waste fibrous media, (b) a disintegrator configured to further process the cut waste fibrous media, mixing it with liquid to form a paste, and (c) a compression unit configured to extract excess liquid from the paste and form the paste into a compressed solid. In preferred implementations, the device further includes (d) a liquid delivery system configured to deliver liquid to the disintegrator and collect liquid pressed out of the paste by the compression unit.

Some implementations may include one or more of the following features.

The shredder may be, for example, an industrial strip-cut paper shredder or cardboard shredder. The device may further include a material chute that is configured to receive shredded fibrous material from the shredder and pass it to the disintegrator. In some implementations the material chute is constructed from sheet metal or a similar material.

In some embodiments, the disintegrator is positioned below the material chute to allow for continuous transmission of shredded fibrous material. The disintegrator may operate in such a fashion as to completely disintegrate all fibrous media into a paste by utilizing a spinning cutting element in an aqueous environment. The disintegrator may also be configured to operate as both a vacuum and a pump, pulling shredded fibrous material from the material chute into the disintegrator and then pushing the fibrous paste from the disintegrator through a material outlet to the compression unit. The addition of a controlled amount of water to the disintegrator reduces the amount of particulate matter that is typically created during a shredding/disintegrating process, in some implementations substantially eliminating the generation of particulate matter.

In some implementations, the compression device comprises a vertically positioned hollow compression chamber, a piston that is configured to travel inside the length of the hollow compression chamber, and a slide gate at the lower end of the hollow compression chamber which acts as a stop for the travel of the piston. The hollow compression chamber may include perforations that allow water to be forced out of the compression chamber when pressure is applied to the paste through the actuation of the piston. In some embodiments, the piston is configured to apply a predetermined amount of pressure to the paste. After exiting the compression chamber through the perforations, the water is returned to the reservoir, resulting in a substantially closed-loop process which requires very little water input. To facilitate this recirculation of liquid, the device may include a liquid collection element disposed beneath the perforated compression chamber to collect liquid exiting the chamber during compression.

In some implementations, the device further includes a controller, e.g., a microprocessor or the like, configured to control operation of the disintegrator and liquid delivery system. The controller may be further configured to control operation of the compression unit.

In another aspect, the invention features a device comprising a disintegration unit which utilizes an aqueous environment to render waste fibrous media into a paste, and a compression unit positioned to receive the paste from the disintegration device and compress the paste.

The invention also features methods of processing waste fibrous media. In one aspect, the invention features a method comprising shredding waste fibrous media, disintegrating the shredded waste fibrous media while mixing it with liquid to form a paste, and compressing the paste to extract excess liquid from the paste and form the paste into a compressed solid.

In some implementations, the method further includes delivering a controlled amount of liquid to the shredded waste during disintegration. The method may also include drying the compressed solid to an extent that the dried compressed solid is combustible, and in some cases burning the dried compressed solid, either at the site at which the compressed solid is formed or at a remote location.

In another aspect, the invention features a method comprising mechanically treating waste fibrous media in a dry environment, further processing the treated waste fibrous media in an aqueous environment, rendering the waste fibrous media into a moist fibrous paste, and mechanically compressing the fibrous paste to extract excess liquid from the paste to form a compressed solid.

The phrase “waste fibrous media,” as used herein, includes waste paper, cardboard, and other sheet materials that include cellulosic or lignocellulosic fibers. These materials may or may not be printed.

### DESCRIPTION OF THE DRAWINGS

FIG. 1 is a side planar view of a multi-stage waste material processing device, with the enclosure wall removed for clarity.

FIG. 2 is a front planar view of the device of FIG. 1, with the enclosure wall removed for clarity.

FIG. 3 is a top view of the device of FIG. 1, with the components of the device shown schematically in phantom lines.

FIG. 4 is an enlarged detail view of the slide gate area of the device of FIG. 1.

FIG. 5 is a schematic view of a disintegrator that may be used in the device of FIG. 1.

### DETAILED DESCRIPTION

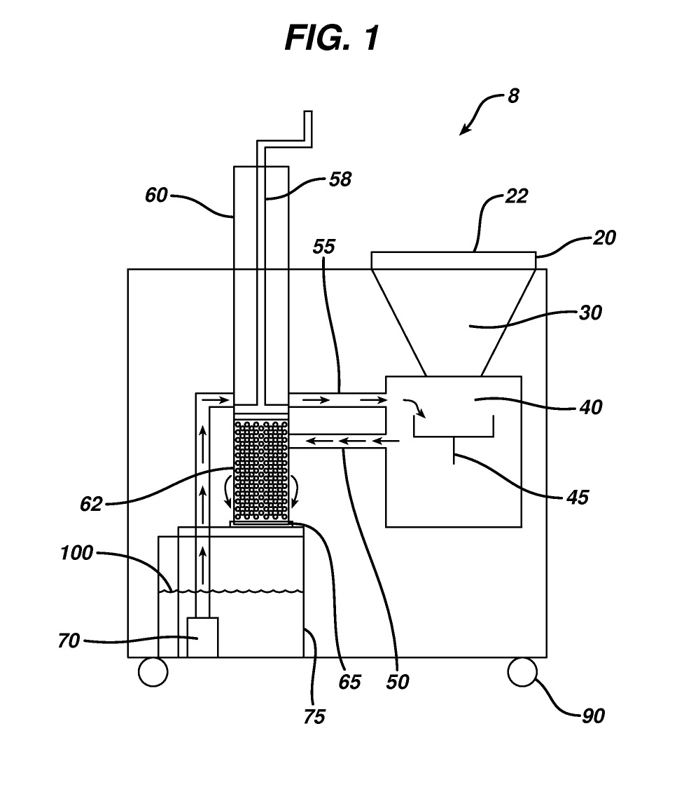

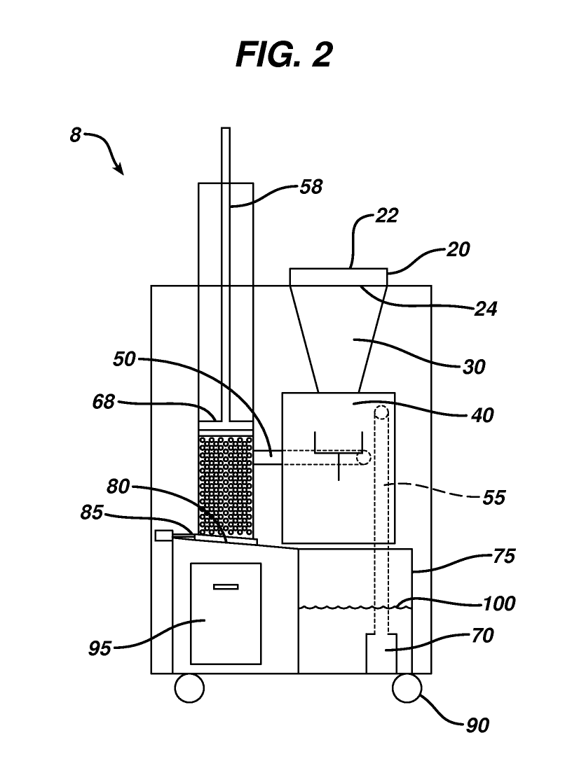

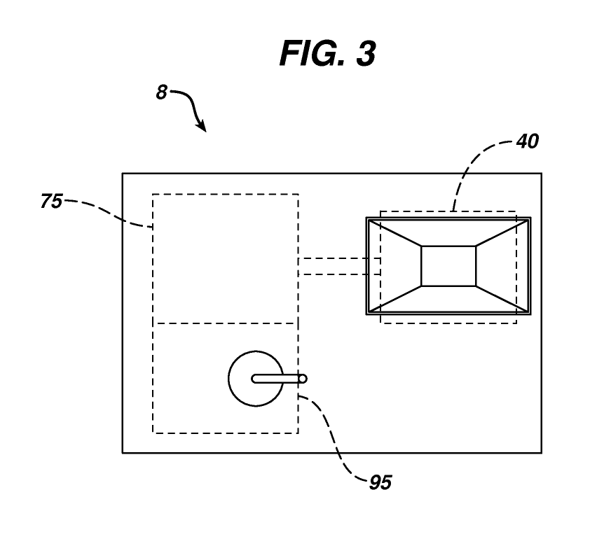

Referring to FIGS. 1-3, a multi-stage waste material processing device 8 includes a sound-insulated enclosure 10, e.g., of sheet metal or other suitable material, in which all the components are housed. The enclosure can be insulated for sound, for example, with a sound-dampening foam liner or other insulating layer with similar qualities. Caster wheels 90 or similar may be mounted to the underside of the enclosure device to allow for easy transport and movement.

An industrial paper or cardboard strip-cut shredder 20 is situated so its inlet 22 is open to the top surface of the exterior of the enclosure, allowing the media to be fed into the device by a user, for example an employee in an office wishing to shred documents. The shredded material exits the shredder outlet 24 to a material chute 30 below. The material chute 30 is situated below the shredder element 20 and is configured to direct shredded media down into a disintegrator 40.

The disintegrator 40, with the addition of a controlled amount of water, which is pumped from an onboard reservoir 75 via a water inlet 55, completely disintegrates incoming shredded media into a paste, thereby effectively destroying all information contained on the media. The addition of water is important both to disintegration of the media and to minimizing airborne particulate which is a typical byproduct of the shredding process. The disintegrator 40 also acts as a vacuum and pump, with a rotating cutting element of the disintegrator drawing shredded material down into the disintegrator 40 from the material chute 30 and then expelling the paste through the material outlet 50 to a compression chamber 60.

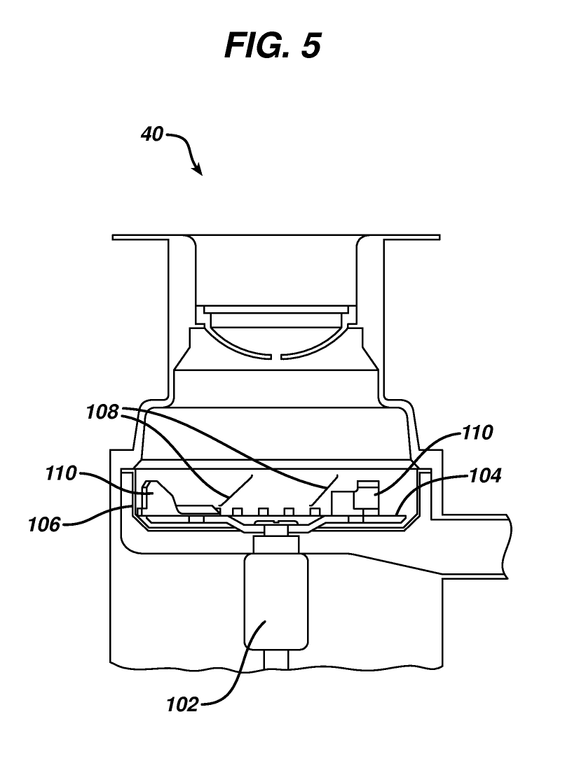

The disintegrator 40 can be, for example, a conventional food or garbage disposal (e.g., an Insinkerator™ disposal or the like). Referring to FIG. 5, in some implementations the disintegrator 40 includes a high-torque, insulated electric motor 102, which may, for example, be rated at 250-750 watts (⅓ to 1 horsepower). This motor spins a circular turntable 104 mounted horizontally above it. The turntable 104 is surrounded by a shredder ring 106, which has cutting surfaces 108. The shredded waste media sits on the turntable and through centrifugal force is forced to its perimeter and through the shredder ring. The turntable has a number of impellers 110 attached to its topside, which assist in forcing the waste through the shredder. The disintegrator may also have an under-cutter blade (not shown) that revolves below the turntable. A suitable type of disintegrating mechanism is shown, for example, in U.S. Pat. No. 3,439,878, the full disclosure of which is incorporated herein by reference.

Various factors, including the overall scale of the waste processing device 8 and the type of fibrous waste media (e.g., paper, cardboard, etc.) being processed, determine the size of the electric motor used to power the disintegrator. Generally, a ½ horsepower motor would be sufficient for disintegration of standard office paper, however the size of motor could vary, for example, from ⅓ to 1½ horsepower.

The liquid is supplied to the disintegrator by a closed-loop liquid delivery system. The liquid reservoir 75 may have, for example, a volume of 4 to 12 gallons, e.g., about 9 gallons, and is situated inside and at the bottom of the device enclosure 10. A submersible pump 70 rests at the bottom of the reservoir and is configured to deliver liquid through the water inlet 55 to the disintegrator 40. An adjustable flow meter (not shown) that is disposed inline with the water inlet 55 can be used to control the amount of water delivered by the submersible pump 70. If desired, a valve (not shown) may be provided instead, or in addition, to regulate the flow of water into the disintegrator 40.

The amount of water to be delivered to the disintegrator will depend on various factors, such as the fibrous media being processed and the amount of water needed for effective transfer of the paste from the disintegrator 40 through the material outlet 50 to the compression unit 60. As an example, generally about 14 ounces of water is needed to disintegrate 6 sheets of 20 pound multipurpose paper. In some implementations, the flow rate of liquid to the disintegrator is about 8 gallons per hour, but the flow rate may be higher or lower depending, for example, on the characteristics of the waste being processed, and could range, for example, from about 6 to 10 gallons per hour. The amount of water required for a particular application can be readily determined empirically and the amount delivered by the pump adjusted accordingly. In some implementations, this determination is made automatically by the waste processing device 8, e.g., by provision of a torque monitor or other device configured to monitor the viscosity of the paste and/or the torque on the disintegrator motor which then transmits this data to a controller so that the controller can adjust flow of water to the disintegrator.

In some implementations, the disintegration step takes about 60 seconds to process 6 sheets of paper. The time required for disintegration will vary depending on the waste fibrous media being processed and the type of disintegrator used.

After disintegration, the material outlet 50 directs the paste into the compression chamber 60 where, with the application of a controlled force through actuation of a piston 68, the paste is compressed. A compression device 58, such as a hand-crank jack or hydraulic press, can be used to manually or automatically actuate the piston 68. A slide gate 65 acts as a stop to the travel of the piston, supporting the paste during compression. In some implementations, the inner diameter of the compression chamber is four inches, but other diameters can be used, for example 2 to 6 inches. The length of the compression chamber may be, for example, about 6 to 14″, e.g., about 10″.

During compression, water is expelled from the paste through small perforations 62 in the wall of the compression chamber 60. The perforations 62 are generally less than 0.5″ in diameter, and may be, for example, about 0.05 to 0.15″ in diameter, e.g., about 0.1″. The high viscosity of the paste, in conjunction with the small size of the perforations 62, inhibits extrusion of the paste out the perforations. It is generally preferred that the wall of the compression chamber have an open area of at least 20%, for example about 25% to 45%, e.g., about 30% to 40% open area. This relatively large open area allows most of the water to be pressed out of the paste during the compression cycle.

The water that is expelled through the perforations runs down the sidewall of the compression chamber (arrows, FIG. 1) and is collected outside the base of the compression chamber on the slide gate and also on the sloped top surface 80 of the collection chamber 95, and directed back to the reservoir 75 where it is reused. Thus, the process is essentially closed-loop with little water loss (water loss being limited to the small amount of water that remains in the paste after compression). Approximately 20 oz of water an hour is lost in the recycling process, assuming continuous use of the device. Generally the liquid reservoir 75 has sufficient capacity allow for approximately 18 hours of operation, after which approximately 3 gallons of water may be added to replace losses.

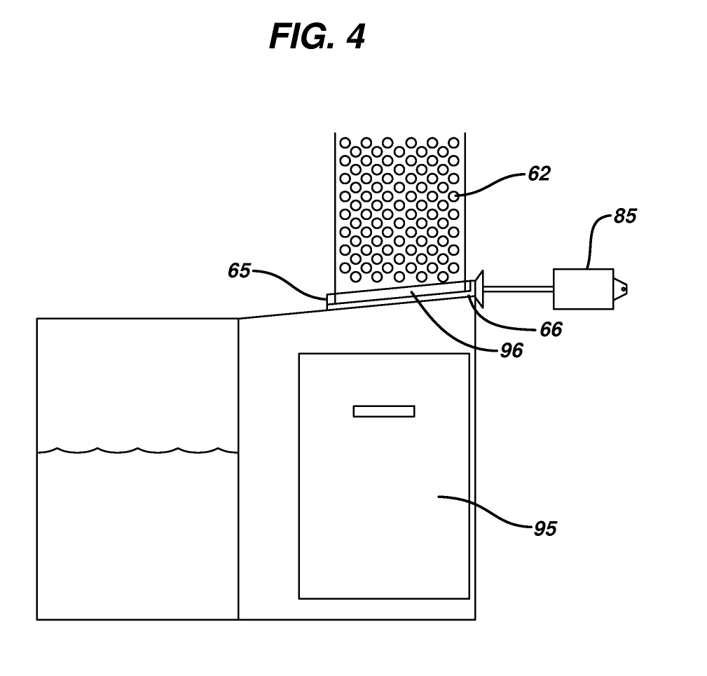

Referring to FIG. 4, the slide gate 65 includes three upwardly extending side walls 66, which provide water control and counter support for pressure generated by the compression device 58 during operation. The slide gate 65 is slightly angled, e.g., at approximately 10 degrees or less, with respect to the horizontal plane to aid water flow back to the reservoir 75. The slide gate 65 has a stroke of about six inches, but other ranges, for example 2 to 9 inches could be utilized and would be determined by the diameter of the compression unit 60 with the minimum stroke being at least equal to that diameter if not greater.

The compression cycle generally takes about 30 to 45 seconds, but other time periods could be anticipated depending on a variety of factors such as water content in the paste, type of compression device utilized, among others.

The paste can be prevented from entering the compression chamber above the piston, during the piston stroke, by pausing the disintegrator during the compression cycle and/or by a valve or gate (not shown) at the material outlet of the disintegrator. In some implementations, a controller is provided that is configured to pause the action of the disintegrator during the compression cycle. This pausing may be manually controlled by the operator of the recycling device 8, or may be automatically controlled, for example by a controller (e.g., a microprocessor or other electronic device) configured to control and synchronize the operation of the disintegrator, pump, and compression device.

The completion of the compression cycle results in a dense, moist log that can be ejected from the compression device 60 into the collection chamber 95 by actuating the slide gate 65. Once the slide gate 65 is opened, the piston 68 pushes the dense log into the collection chamber 95. Closing the slide gate 65 during the ejection process sections the moist log to the desired length. This function can be manually performed or automatically controlled, e.g., by the controller discussed above. The moist, dense log can be then removed from the collection chamber 95 through a collection door 98 on the exterior of the device enclosure 10. The piston 68 is then returned to the top of its stroke to ready it for the next compression cycle.

The exact pressure applied to compress the disintegrated fibrous paste is not a critical feature. Generally, a range of 300 lb to 3000 lb would be acceptable, however in some applications the range could be even broader as dictated by the application, the amount of water added in the disintegrator 40 and the fibrous media being recycled. Generally, greater pressure will increase energy consumption, but could also reduce energy consumption during drying in a dryer and/or the air drying time of the finished product.

After removal from the collection chamber, the log may be dried by air drying or using a dryer, e.g., a tunnel oven or other drying device.

The waste processing device 8 may be powered, for example, by a standard 115V power cord with a GFCI plug. A user interface (not shown) is generally provided, which may include, for example, a start/stop button and an emergency stop button. These may be located, for example, on top of the enclosure. The waste processing device 8 uses approximately 5 amps current, e.g., from 4 to 6 amps. If the device is fully automatic all of its components may be controlled by a single controller, e.g., a microprocessor, via a single on/off button. Alternatively, separate controls can be provided to actuate the pump, compression jack (if automatic), and disintegrator.

The device may be used, for example, on ships, in offices, hospitals, etc., for on site disposal of waste media, e.g., sensitive documents, without generation of excessive dust and with minimal water and energy consumption. In some implementations, the complete process to form a single log takes 5-10 minutes to complete. Processing time will depend on the volume of waste media fed to the device and other factors. As one example, complete processing of 42 sheets of standard office paper took approximately 7 minutes, resulting in a finished moist log 3 inches long with a diameter of 4 inches. Air drying time for this example was approximately five days.

### Other Embodiments

A number of embodiments have been described. Nevertheless, it will be understood that various modifications may be made without departing from the spirit and scope of the disclosure.

For example, the device can be scaled to meet the requirements of various applications. Variations of the device could comprise changing the size and capacity of the initial shredder, changing the size and capacity of the disintegrator and the compression unit, and changing the capacity of the liquid reservoir. It should be understood that altering the scale of the machine could change the total processing time necessary as well as the water necessary for disintegration and the finished log size.

Moreover, the relative positioning and orientation of the various components of the device may be altered as desired, e.g., to suit a particular application.

While a cylindrical compression chamber, configured to produce logs, is discussed above, the compression chamber may have any desired shape or cross-sectional geometry, for example may be square or rectangular in cross-section, in which case the piston would be shaped correspondingly so as to slide freely within the compression chamber.

Additionally, some embodiments could utilize partial or full automation, e.g., utilizing a controller as discussed above. For instance, integrated automated operation of the slide gate and compression device may be used to facilitate ejection of the finished compressed log. As discussed above, some embodiments utilize an automated compression device, for example utilizing a hydraulic or electrical mechanism to generate the necessary pressure, which then deactivates once a predetermined pressure is achieved. Deactivation could be accomplished in a variety of ways, including a pressure sensitive switch associated with the slide gate.

While circular perforations are shown in the figures, the perforations can have any desired geometry.

Some embodiments may include a dryer that is integrated into the collection bin or otherwise associated with the device to decrease drying time of the compressed material.

Accordingly, other embodiments are within the scope of the following claims.

What is claimed is:

1. A device comprising:
a shredder configured to cut waste fibrous media,
a disintegrator configured to further process the cut waste fibrous media, mixing it with a liquid to form a paste, and
a compression unit configured to extract excess liquid from the paste and form the paste into a compressed solid.

2. The device of claim 1 further comprising a liquid delivery system configured to deliver liquid to the disintegrator and collect liquid pressed out of the paste by the compression unit.

3. The device of claim 1 wherein the disintegrator comprises a shredder element configured to spin about an axis that is generally parallel to a long axis of the compression unit.

4. The device of claim 1 wherein the disintegrator comprises a motor.

5. The device of claim 1 wherein the disintegrator comprises an impeller that assists in delivering the paste from the disintegrator to the compression unit.

6. The device of claim 2 wherein the disintegrator comprises a turntable that supports the cut waste fibrous media.

7. The device of claim 1 wherein the compression unit comprises a perforated chamber and a piston configured to slide within the chamber.

8. The device of claim 6 wherein the compression unit further comprises a compression jack configured to apply pressure to the piston and thereby compress the paste within the chamber.

9. The device of claim 7 further comprising an automatic actuator configured to actuate the compression jack during a compression cycle of the device.

10. The device of claim 9 further comprising a controller configured to pause the disintegrator during the compression cycle.

11. The device of claim 1 wherein the liquid delivery system comprises a reservoir and a pump configured to deliver liquid from the reservoir to the disintegrator.

12. The device of claim 11 wherein the compression unit comprises a perforated compression chamber and the liquid delivery system further comprises a liquid collection element disposed beneath the perforated compression chamber to collect liquid exiting the chamber during compression.

13. The device of claim 1 further comprising a controller configured to control operation of the disintegrator and liquid delivery system.

14. The device of claim 13 wherein the controller is further configured to control operation of the compression unit.

15. The device of claim 1 wherein the compression unit is configured to form the paste into a cylindrical log.

16. A device comprising:
a disintegration unit which utilizes an aqueous environment to render waste fibrous media into a paste, and
a compression unit positioned to receive the paste from the disintegration device and compress the paste.

17. A method comprising:
shredding waste fibrous media,
disintegrating the shredded waste fibrous media while mixing it with liquid to form a paste, and
compressing the paste to extract excess liquid from the paste and form the paste into a compressed solid.

18. The method of claim 17 further comprising delivering a controlled amount of liquid to the shredded waste during disintegration.

19. The method of claim 17 further comprising drying the compressed solid to an extent that the dried compressed solid is combustible.

20. The method of claim 19 further comprising burning the dried compressed solid.

21. A method comprising:
mechanically treating waste fibrous media in a dry environment;
further processing the treated waste fibrous media in an aqueous environment, rendering the waste fibrous media into a moist fibrous paste; and
mechanically compressing the fibrous paste to extract excess liquid from the paste, resulting in a compressed solid.
